(19) United States
(12) Patent Application Publication
(10) Pub. No.: US 2010/0121778 A1
(43) Pub. Date: May 13, 2010

(54) Systems and Methods for Providing a Secure Financial Plan

(75) Inventors: George A. Castineiras, Farmington, CT (US); Christine C. Marcks, Glastonbury, CT (US)

Correspondence Address: BAKER BOTTS L.L.P., 2001 ROSS AVENUE, SUITE 600, DALLAS, TX, 75201-2980, US

(73) Assignee: The Prudential Insurance Company of America, Newark, NJ (US)

(21) Appl. No.: 12/268,296

(22) Filed: Nov. 10, 2008

(51) Int. Cl. G06Q 40/00

(52) U.S. Cl. 705/36 R; 705/39

(57) ABSTRACT

One embodiment of the disclosure is a method for providing a secure financial plan that includes allocating all or a portion of a financial contribution to a financial account having a plurality of financial investments, periodically distributing a balance of the financial account such that a first portion of the balance of the financial account is invested in one or more investments from the of the high risk investment category and a second portion of the balance of the financial account is invested in one or more investments from the low risk investment category, such that a ratio of the first portion to the second portion is generally decreased over a period of time. The method further includes determining a base value, calculating a protected value, and an income amount based on the protected value that a beneficiary is guaranteed to receive on a periodic basis.

### TECHNICAL FIELD

This disclosure relates generally to financial plans and more particularly to systems and methods for providing a secure financial plan.

### BACKGROUND

There are numerous financial plans available on the market and people invest in them for a variety of reasons. A financial plan may be offered by a plan sponsor to one or more investors. For example, a plan sponsor may offer a financial plan to one or more employees. A financial plan offered by a plan sponsor typically allows investors to select and buy one or more financial investments. Some investors are interested in obtaining high rates of return on their investments, while others are willing to forego high rates of return in exchange for a reduced level of financial risk. Some investors are interested in obtaining a steady income stream for a period of years or possibly for life upon retirement. However, some investors may not have the expertise to properly diversify their portfolio of investments to maximize the growth of their investments in the early phases of the financial plan and to minimize the financial risk of their investments in the later phases of the financial plan to ensure a steady income stream upon retirement.

When making decisions regarding the selection of a financial plan, there are multiple tradeoffs. Typically, a financial plan that provides more flexibility and options to the investor will include more costs than a financial plan that provides little or no options to the investor. There are also numerous tax consequences that may be considered in selecting a financial plan. Some financial plans, such as 401(k) plans, provide tax-deferred benefits to investors.

In certain situations, a plan sponsor may be viewed as a fiduciary to an investor. As more investors rely on the financial plan offered by the plan sponsor to provide a steady income stream upon retirement, plan sponsors may become more susceptible to lawsuits associated with the financial performance of the financial plan. Thus, providing adequate financial plans to investors and protecting themselves from such lawsuits presents a significant challenge to plan sponsors.

### Overview

According to certain embodiments, a method for providing a secure financial plan includes storing identifying information for an account holder, such that the account holder is participating in a financial plan. The method also includes allocating all or a portion of a financial contribution to a financial account having a plurality of financial investments, such that the plurality of financial investments comprising at least one investment from each of a high risk investment category and a low risk investment category, such that the combination of investments in the high risk investment category have a higher expected rate of return and a higher risk than the combination of investments in the low risk investment category. The method further includes periodically distributing a balance of the financial account such that a first portion of the balance of the financial account is invested in one or more investments from the high risk investment category and a second particular percentage of the balance of the financial account is invested in one or more investments from the low risk investment category, such that a ratio of the first portion to the second portion is generally decreased over a period of time. The method also includes, in response to a first triggering event, determining a base value, such that the base value is substantially equal to the balance of the financial account. The method also includes, in response to a second triggering event, calculating a protected value, such that the protected value is at least equal to the base value, and calculating an income amount based on the protected value that a beneficiary is guaranteed to receive on a periodic basis.

According to certain embodiments, a method, performed by a sponsor offering a financial plan to a customer, for transferring risk associated with the financial plan includes receiving indemnification from an issuer managing the financial plan, such that the indemnification indemnifies the sponsor of the financial plan for one or more claims brought by the customer of the financial plan and associated with a performance of a financial account associated with the financial plan and including one or more financial investments. The method further includes using software stored on computer-readable media and, when executed by one or more processors, operable to generate a notice to the customer, such that the notice notifies the customer of the customer's enrollment in the financial plan unless the customer elects to opt out of one or more features of the financial plan and the notice comprising a waiver. The method further includes using software stored on computer-readable media and, when executed by one or more processors, operable to store an indicator, in one or more memory modules, such that the indicator represents an acknowledgement of the waiver by the customer.

Certain embodiments may provide various technical advantages. For example, certain embodiments may allow an account holder to participate in a secure retirement fund that automatically accumulates contributions and guarantees income distribution for life. Certain embodiments may allow a plan sponsor to receive indemnification from an issuer for claims brought by customers and based on the financial performance of a financial plan. Certain embodiments may allow an account holder to maintain liquidity in an account while at the same time receiving a guarantee of lifetime income and a guaranteed growth rate. Certain embodiments may also allow an account holder to receive the potentially higher rates of return associated with high risk investments while at the same time avoiding the associated risk of loss by obtaining a guaranteed growth rate. Certain embodiments may allow a third-party, such as a plan issuer, to make all investment decisions to maximize the financial benefits of a financial plan. Certain embodiments may also allow an account holder to retain control over certain investment decisions as limited by issuer, such that these investment decisions have only a nominal effect on the performance of financial account while allowing account holder to maintain a sense of ownership. Certain embodiments may provide a “glide path” for a financial plan customer by automatically rebalancing the value of an account between low risk investments and high risk investments, such that the percentage of value in low risk investments increases over time to automatically reduce financial risk as the customer approaches retirement.

Certain embodiments of the present disclosure may provide additional various technical advantages. Certain embodiments may require the account holder to waive certain rights (or acknowledge a waiver of certain rights) if the account holder opts out of the financial plan. Certain embodiments may reduce a plan sponsor's risk of being financially liable for a claim brought by a customer in a lawsuit associated with the financial performance of a financial plan. Certain embodiments may provide automated funding of a financial account associated with a financial plan by allocating a portion of the account holder's salary. Certain embodiments may allow for automated investment on behalf of an account holder.

Other technical advantages of the present disclosure will be readily apparent to one skilled in the art from the following figures, descriptions, and claims. Moreover, while specific advantages have been enumerated above, various embodiments may exhibit combinations of advantages that may include all, some, or none of the enumerated advantages.

### BRIEF DESCRIPTION OF THE DRAWINGS

For a more complete understanding of the present disclosure and its advantages, reference is now made to the following description, taken in conjunction with the accompanying figures, in which:

FIG. 1 illustrates a system for providing a financial plan according to a particular embodiment of the present disclosure;

FIG. 2 illustrates an example asset distribution within a financial account;

FIG. 3 illustrates a table of example asset distributions within a financial account based on age;

FIG. 4 illustrates a financial instrument according to a particular embodiment;

FIGS. 5A-5C provide a flowchart illustrating the operation of a financial plan according to a particular embodiment;

FIG. 6 illustrates an example financial plan opt-out and acknowledgement of financial plan to customer;

FIGS. 7A-7B illustrate an example data processing system for providing a financial plan according to a particular embodiment;

FIG. 8 illustrates an example for determining protected value; and

FIG. 9 illustrates an embodiment of a general purpose computer.

### DETAILED DESCRIPTION OF THE EXAMPLE EMBODIMENTS

It should be understood at the outset that although example implementations of embodiments of the disclosure are illustrated below, the present disclosure may be implemented using any number of techniques, whether currently known or not. The present disclosure should in no way be limited to the example implementations, figures, and techniques illustrated below. Additionally, the figures are not necessarily drawn to scale.

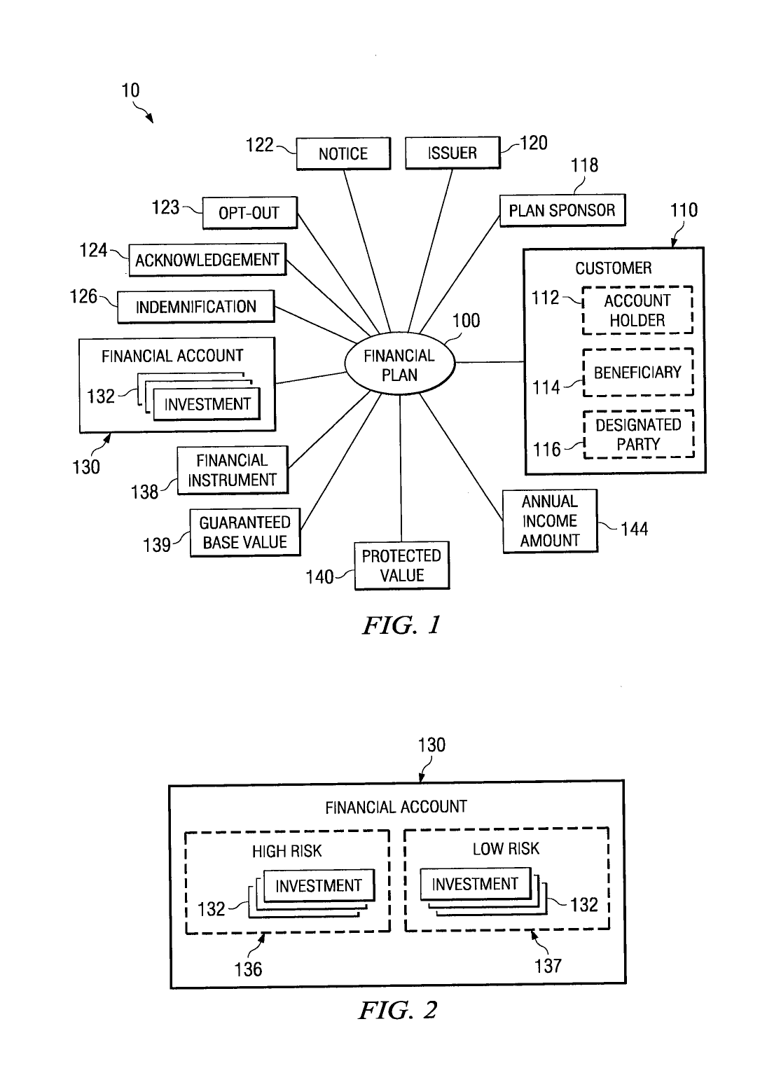

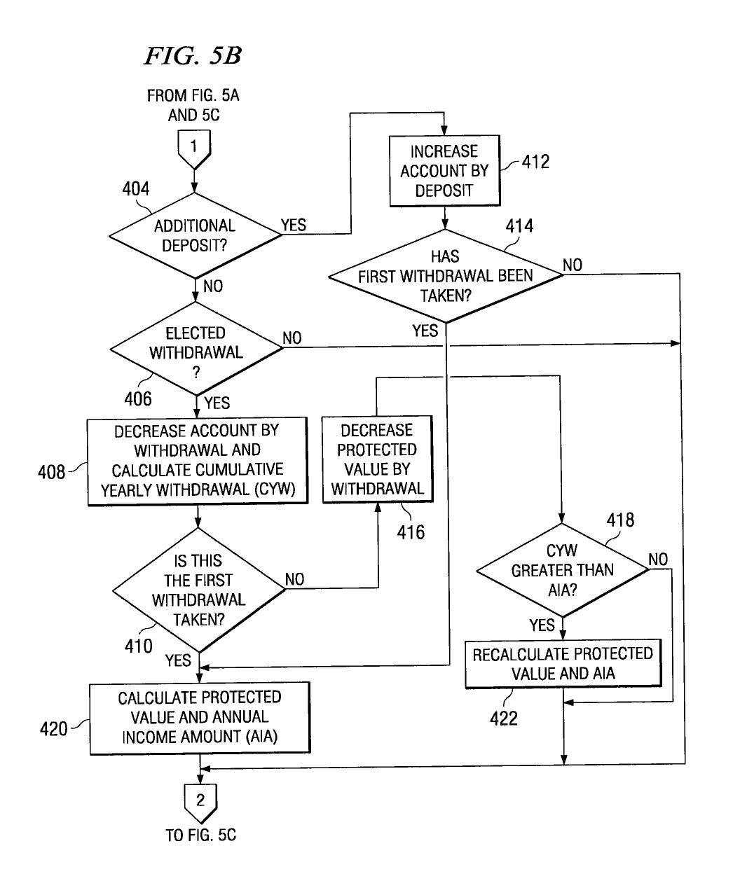

FIG. 1 illustrates a system for providing a financial plan 100 according to a particular embodiment of the present disclosure. System 10 may interact with customer 110, plan sponsor 118, and issuer 120; and system 10 may utilize notice 122, opt-out 123, acknowledgement 124, indemnification 126, financial account 130, financial instrument 138, guaranteed base value 139, protected value 140, and annual income amount 144. Financial plan 100 may represent an agreement between customer 110 and issuer 120, customer 110 and plan sponsor 118, and/or plan sponsor 118 and issuer 120. Customer 110 may represent one or more of account holder 112, beneficiary 114, and designated party 116. Plan sponsor 118 may represent an employer of customer 110 and/or account holder 112. Financial instrument 138 may include certain provisions as described below in relation to FIG. 4.

According to certain embodiments, system 10 may be utilized to provide financial plan 100 to customer 110. According to certain embodiments, customer 110 may receive notice 122 of financial plan 100, such that notice 122 may explain the terms and conditions of financial plan 100. According to certain embodiments, customer 110 may be required to execute or otherwise acknowledge opt-out 123 if customer 110 elects to opt-out of financial plan 100. In certain embodiments, opt-out 123 may represent a relinquishment of any rights to file a lawsuit against plan sponsor 118 based on the financial performance of financial account 130. According to certain embodiments, system 10 may store acknowledgement 124 of opt-out 123, or opt-out 123 itself, for one or more customers 110. In certain embodiments, system 10 may automatically deposit portions of a salary to a balance in financial account 130, such that the balance in financial account 130 is automatically invested in a portfolio of diversified financial investments 132. In certain embodiments, system 10 may automatically rebalance the distribution of the value of financial account 130 between low risk investments 137 and high risk investments 136, such that the exposure to high risk investments 136 is generally decreased as customer 110 becomes older in age. According to certain embodiments, at a first triggering event (e.g., when customer 110 turns fifty years old), issuer 120 may issue financial instrument 138, determine guaranteed base value 139, guarantee a growth rate of guaranteed base value 139, and guarantee lifetime financial transfers to customer 110 for life. It contains embodiments, customer 110 may receive the benefits of such guarantees even if financial account 130 loses value or is completely depleted. According to certain embodiments, at a second triggering event (e.g., when customer turns seventy years old), customer 110 begins to receive annual income amount 144 for life. Annual income amount 144 may be a percentage of protected value 140. System 10 may determine protected value 140 by using the highest value from one of numerous calculations, such that customer 110 is guaranteed to have a higher protected value 140 than guaranteed base value 139 even if investments 132 in financial account 130 lose value. Thus, in certain embodiments, system 10 may allow customer 110 to participate in a secure retirement fund that automatically accumulates funds, guarantees growth of those funds, and guarantees income distribution for life. In certain embodiments, system 10 may utilize a defined contribution plan, such as a 401(k) plan. System 10 may be utilized to allow issuer 120 to provide indemnification 126 to plan sponsor 118 for certain claims brought by customer 110. In particular embodiments, indemnification may apply regardless of whether customer 110 opts out of financial plan 100 or participates in financial plan 100.

Financial plan 100 may represent a secure retirement fund for customer 110. In certain embodiments, financial plan 100 may represent or include a group annuity contract. In certain embodiments, financial plan may include an individual retirement account contract, a mutual fund contract, a funding agreement, a 401(k) contract, and/or an annuity contract. In certain embodiments, financial plan 100 may be offered within a defined contribution plan. A defined contribution plan may refer to a tax deferred retirement savings plan. In certain embodiments, a defined contribution plan may be a 401(k) plan, 401(b) plan, employee stock ownership plan, profit sharing plan, etc. Financial plan 100 may include provisions of the terms and conditions specifying a monetary contribution to deposit in financial account 130. In certain embodiments, a contribution may be a portion of customer's 110 salary, a deposit by customer 110, a deposit by plan sponsor 118, a deposit by a third party, etc. In certain embodiments, the portion of customer's 110 salary to be contributed to financial account 130 may increase periodically over time. For example, the portion of customer's 110 salary by one percent or more at a particular date each year. In certain embodiments, the portion of customer's 110 salary to be contributed to financial account 130 may be limited by laws or Internal Revenue Service (IRS) guidelines. In certain embodiments, the balance and/or the contribution may be distributed between financial investments 132, including low risk investments 137 and high risk investments 136. In certain embodiments, the distribution between low risk investments 137 and high risk investments 136 may be based upon the age of customer 110, the number of years until the planned retirement of customer 110, the number of years customer 110 has been employed by a particular employer, the number of years customer 110 has been enrolled in financial plan 100, or any other appropriate characteristic. In certain embodiments, financial plan 100 may also include provisions of the terms and conditions of indemnification 126.

Customer 110 may broadly refer to one or more of an account holder 112, a beneficiary 114, a designated party 116, one who participates in financial plan 100, and/or one who is issued financial instrument 138 for another person or entity. In certain embodiments, account holder 112 may represent a party who makes contributions to financial account 130 associated with financial plan 100 and/or who is attributed as being an owner of financial account 130. In certain embodiments, these contributions may be made in the form of deferred compensation from an employer. In particular embodiments, the employer of customer 110 may also make contributions, such as matching contributions, to financial account 130. In certain embodiments, account holder 112 may have one or more ownership rights in financial account 130. For example, account holder 112 may have the right to opt-out of financial plan 100, to identify one or more beneficiaries 114, to identify one or more designated parties 116, and/or to make deposits into financial account 130. In a particular embodiment, account holder 112 may be the entity or entities who have tax liability for the transactions related to financial account 130. In certain embodiments, beneficiary 114 may represent a party who may receive payments and/or make withdrawals in accordance with the terms of financial instrument 138 associated with financial plan 100. In certain embodiments, designated party 116 may represent an individual, group of individuals, and/or other entity that may be designated for purposes of determining death benefits, lifetime payments, fees, guaranteed rates, expected liabilities, and/or other features of financial instrument 138. For example, guaranteed rates and/or fees may be determined based upon the age, gender, and/or health of designated party 116. As yet another example, death benefit provisions may be based upon the death of designated party 116.

In certain embodiments, one or more of account holder 112, beneficiary 114, and designated party 116 may be the same party. In certain embodiments, account holder 112 may assign benefits of financial instrument 138 to beneficiary 114, with designated party 116 being the designated life for the guarantee of lifetime payments.

In certain embodiments, one or more of account holder 112, beneficiary 114, and designated party 116 may be related. For example, designated party 116 and beneficiary 114 may be related as husband and wife. As another example, account holder 112 may be an employer and an employee may be both beneficiary 114 and designated party 116. Alternatively, account holder 112 and beneficiary 114 may be the same individual or entity. In some embodiments, an employer might add funds to financial account 130 for account holder 112. Also, financial instrument 138 may have multiple account holders 112, beneficiaries 114, and/or designated parties 116. For example, a husband and a wife may both be beneficiaries 114 and designated parties 116. As another example, two or more business partners could be designated parties 116. While this patent describes various actions, benefits, steps, etc. in relation to a customer 110, account holder 112, beneficiary 114, and/or designated party 116, those descriptions should not be construed as limiting because financial instrument 138 might provide for various persons to exercise control, take various actions, receive certain benefits, and/or affect certain features with regard to financial instrument 138.

Plan sponsor 118 may present financial plan 100 to one or more customers 110 although financial plan 100 may be managed or offered by issuer 120. In certain embodiments, plan sponsor 118 may represent an employer of customer 110 or account holder 112. In certain embodiments, plan sponsor 118 may be an organization, union, club, partnership, business entity, etc., such that customer 110 or account holder 112 may be a member of plan sponsor 118. Plan sponsor 118 may provide compensation, such as a salary, to account holder 112, and plan sponsor 118 may contribute a portion of the compensation to financial account 130. In certain embodiments, plan sponsor 118 may represent an indemnitee that receives indemnification 126, such as litigation insurance, from issuer 120. In certain embodiments, plan sponsor 118 may receive indemnification 126 from issuer 120 at a time preceding or following a time when financial plan 100 is offered to customer 110. In certain embodiments, plan sponsor 118 may receive indemnification 126 from issuer 120 at the same time as financial plan 100 is offered to customer 110. In certain embodiments, such litigation insurance may cover the expenses and damages resulting from claims brought by customer 110 against plan sponsor 118. In certain embodiments, plan sponsor 118 may be legally responsible for fiduciary claims brought by customer 110, but litigation insurance provided by issuer 120 may reimburse plan sponsor 118 for all monetary expenses and damages associated with claims based on financial plan 100. Such claims may include those associated with the financial outcome of participation by customer 110 in financial plan 100. In certain embodiments, litigation insurance may cover claims associated with the financial outcome of investments by customer 110 if customer 110 opts out of one or more aspects of financial plan 100. In particular embodiments, indemnification 126 may cover any claims against plan sponsor 118 under §404(c) of the Employee Retirement Income Security Act (ERISA), fiduciary breach of plan sponsor 118, etc. In certain embodiments, indemnification 126 provided by issuer 120 may cover claims against plan sponsor 118 brought by a single customer 110 in addition to claims brought by a class action of customers 110.

Issuer 120 may represent an entity that provides and/or manages financial plan 100. Issuer 120 may represent a bank, an insurance company, or other business entity engaged in the sale of one or more financial plans and/or financial instruments. In certain embodiments, issuer 120 may transparently provide and/or manage financial plan 100 for customers 110, such that customers 110 may not be aware of the involvement of issuer 120. Issuer 120 may also represent multiple entities that operate together to provide or sell financial plan 100 and/or financial instrument 138. Issuer 120 may receive fees associated with financial plan 100 from customer 110 and/or plan sponsor 118. In certain embodiments, issuer 120 may represent an indemnitor that provides indemnification 126, such as litigation insurance, to plan sponsor 118. In certain embodiments, issuer 120 may provide indemnification 126 to plan sponsor 118 at a time preceding or following a time when financial plan 100 is offered to customer 110. In certain embodiments, issuer 120 may provide indemnification 126 to plan sponsor 118 at the same time as financial plan 100 is offered to customer 110.

Notice 122 may represent a notification to customer 110 of all or a portion of the terms and conditions of financial plan 100. The terms and conditions of financial plan 100 may provide details associated with a particular financial plan 100 presented by plan sponsor 118. In certain embodiments, terms and conditions may specify the amount of contribution to be made by customer 110 and/or plan sponsor 118, the date issuer 120 will issue financial instrument 138, the guaranteed growth rate of financial instrument 138, etc. In certain embodiments, notice 122 may notify customer that customer 110 will automatically participate in financial plan 100 unless customer 110 chooses to opt-out of financial plan 100. Customer 110 may opt-out of the entire financial plan 100, or customer 110 may opt-out of certain aspects of financial plan 100. Customer 110 may choose to opt-out of financial plan 100 at any time unless customer 110 is otherwise notified. Notice 122 may be in electronic or paper form. In certain embodiments, electronic notice 122 may be in form of a pop-up window, hyperlink, e-mail, SMS message, etc. In certain embodiments, paper notice 122 may be in form of a letter, interoffice memo, employee welcome packet, etc. In certain embodiments, system 10 may automatically generate notice 122 for customer 110. In embodiments in which customer 110 is an employee of plan sponsor 118, notice 122 may be generated when customer 110 is first hired by plan sponsor 118. In particular embodiments, notice 122 may be generated for current employees of plan sponsor 118 upon initial presentations of financial plan 100 to those employees. In particular embodiments, notice 122 may be sent in an e-mail on behalf of plan sponsor 118, such that the e-mail may include a link to an on-line seminar describing financial plan 100.

In certain embodiments, a second notice 122 may be generated at a particular time or upon the occurrence of a triggering event. In certain embodiments, second notice 122 may notify customer of the impending issuance of financial instrument 138. In certain embodiments, this triggering event may occur forty-five days prior to the issuance date of financial instrument 138. In certain embodiments, triggering event may be a date selected by customer 110, plan sponsor 118, and/or issuer 120. In certain embodiments, other triggering events may include a particular age of customer 110, a certain number of years customer 110 has been employed by plan sponsor 118, etc.

Opt-out 123 may represent the relinquishment of certain legal rights of customer 110. In certain embodiments, opt-out 123 may represent a waiver by customer 110 of any right to file a lawsuit associated with the financial performance of financial account 130 if customer 110 opts out of certain aspects of financial plan 100. In certain embodiments, customer 110 may waive the right to bring a claim associated with the financial performance or selection of any financial investments purchased outside financial plan 100. In particular embodiments, customer 110 may waive the right to bring any claims against plan sponsor 118 and/or issuer 120 under §404(c) of ERISA, fiduciary breach of plan sponsor 118 and/or issuer 120, etc. In certain embodiments, opt-out 123 may be included in notice 122. In certain embodiments, opt-out 123 may be separate from notice 122. Similar to notice 122, opt-out 123 may be in electronic or paper form. Issuer 120 and/or plan sponsor 118 may store the electronic or paper forms of opt-out 123.

Acknowledgement 124 may represent an indication that customer 110 is opting out of one or more aspects of financial plan 100. In certain embodiments, acknowledgment 124 may indicate that customer 110 accepts opt-out 123. In certain embodiments, acknowledgement 124 may indicate that customer 110 opts out of a particular aspect of financial plan 100, such as automatically making contributions to financial account 130, the issuance of financial instrument 138, the benefit of receiving a guaranteed growth rate, the benefit of receiving a guaranteed income for life, etc. In certain embodiments, acknowledgement 124 may provide evidence of opt-out by customer 110. In certain embodiments, acknowledgement 124 may indicate that customer 110 accepts opt-out 123. Customer 110 may be required to indicate acknowledgement 124 of opt-out 123 before customer 110 can opt-out of financial plan 100. Opt-out 123 and/or acknowledgement 124 may include any action by customer 110 that indicates customer 110 is opting out of one or more aspects of financial plan 100, such as clicking an electronic button in a graphical user interface, an electronic signature on a webpage, sending a statement by an e-mail, sending a statement by mail, a signature on a paper form, etc. In certain embodiments, opt-out 123 may require customer 110 to acknowledge that customer 110 is opting out of a guaranteed income for life. Similar to notice 122, acknowledgement 124 may be in electronic or paper form.

Issuer 120 and/or plan sponsor 118 may store the electronic or paper forms of opt-out 123 and/or acknowledgements 124. For example, opt-out 123 and/or acknowledgements 124 may be stored in file cabinet, computer memory, e-mail attachments, etc. In certain embodiments, notice 122, opt-out 123, and/or acknowledgement 124 may be integrated in the same document or may be included in separate documents. In certain embodiments, issuer 120 and/or plan sponsor 118 may store an indicator associated with each customer 110, such that the indicator may represent if customer 110 has provided opt-out 123 and/or acknowledgement 124 of opting out of one or more aspects of financial plan 100. In certain embodiments, the indicator may be used in electronic or paper form. For example, the indicator may be used in association with a graph in paper form, a relational database, a table in electronic form, an electronic spreadsheet, a paper spreadsheet, etc.

Indemnification 126 may represent an agreement between issuer 120 and plan sponsor 118, such that issuer 120 provides litigation insurance to plan sponsor 118 for claims associated with the financial performance of financial account 130 brought by customer 110 enrolled in financial plan 100. Indemnification 126 may represent a transfer of risk associated with financial plan 100, such that risk is transferred from plan sponsor 118 to issuer 120. As mentioned above, in certain embodiments, issuer 120 may provide indemnification to plan sponsor 118 as to claims associated with financial performance of financial account 130 brought by customer 110 who opted out of financial plan 100, such that investments 132 in financial account 130 were personally managed by customer 110. As mentioned above, although other types of claims are contemplated example claims covered by indemnification 126 may include any claims against plan sponsor 118 and/or issuer 120 under §404(c) of ERISA, fiduciary breach of plan sponsor 118 and/or issuer 120, etc.

Financial Account 130 may represent a principal balance including contributions and the accrued growth due to a return on one or more investments 132. In certain embodiments, the contribution amount to fund financial account 130 may be specified by financial plan 100. In certain embodiments, the contribution amount to fund financial account 130 may change after it has been initially determined. As one example, the contribution amount to fund financial account 130 may be limited based upon one or more laws. In certain embodiments, financial account 130 may be in a defined contribution environment, such as a 401(k) account.

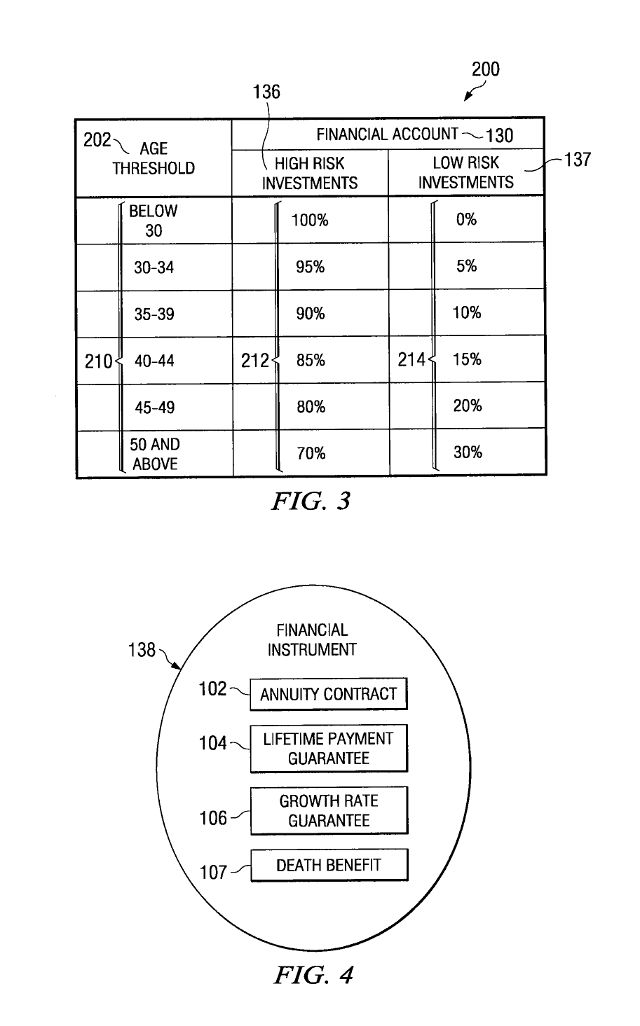

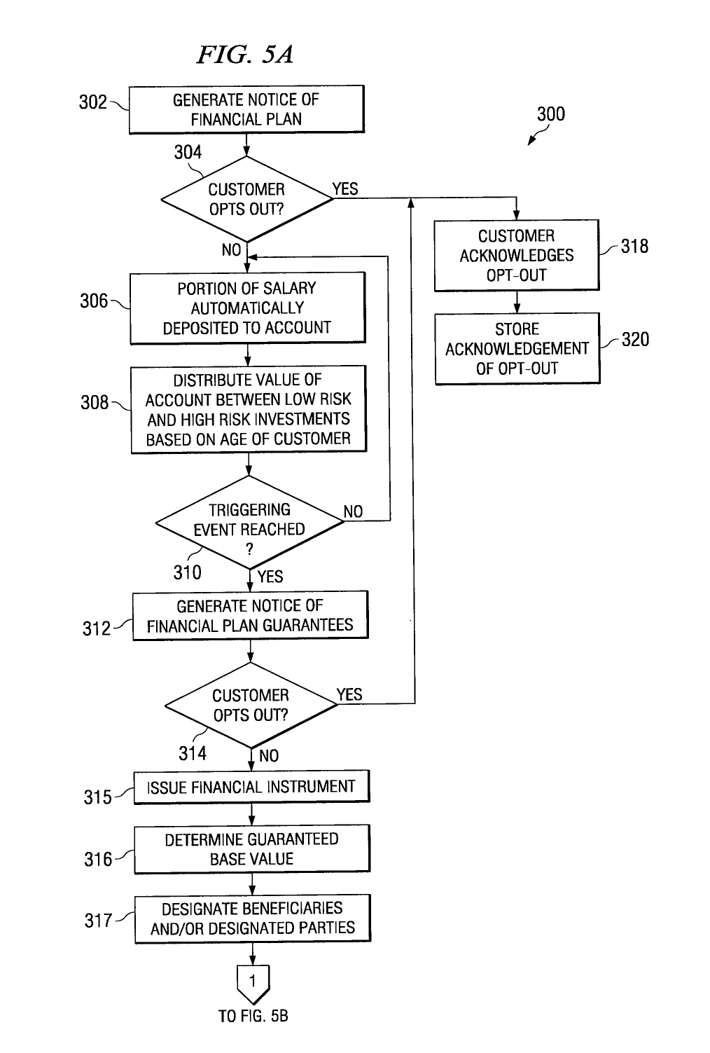

The value of financial account 130 may be distributed among one or more investments 132, such that investments may include high risk investments 136 and low risk investments 137. In certain embodiments, financial plan 100 may generally increase the portion or the percentage of the value of low risk investments 137 included in financial account 130 as customer 110 increases in age, such that the exposure to high risk investments 136 is lowered. For example, the ratio of the portion of low risk investments 137 to the portion of high risk investments 136 is generally decreased over a period of time. In certain embodiments, it is possible that the portion or the percentage of the value of low risk investments 137 included in financial account 130 may slightly increase or flat line as customer 110 increases in age, but over a long period of time, the portion or the percentage of the value of low risk investments 137 will generally increase as customer 110 increases in age. Further explanation of high risk investments 136 and low risk investments 137 in an example asset distribution within financial account 130 is included below in relation to FIG. 2. Further explanation of an example table for distributing the value of financial account 130 between high risk investments 136 and low risk investments 137 is included below in relation to FIG. 3.

In certain embodiments, high risk investments 136 may provide a variable return with a higher variance of gain or loss than low risk investments 137. Low risk investments 137 may provide a variable or fixed return with a lower variance of gain or loss than high risk investments 136. In certain embodiments, issuer 120 may determine which financial investments 132 are considered low risk investments 137 and high risk investments 136. For example, financial investments 132 may represent a municipal bond, a bond fund, a money market account, a corporate security, an index fund, a mutual fund, a real estate investment trust, hedges, swaps, derivatives, cash, or any other appropriate type of investment. In certain embodiments, issuer 120 may include securities and/or medium to high risk mutual funds as high risk investments 136. In certain embodiments, issuer 120 may include money market accounts, low risk mutual funds, index funds, and/or bond funds as low risk investments 137. In a particular embodiment, issuer 120 may include one or more private securities, one or more public corporate bonds, one or more mortgage loans, one or more private securities, one or more government bonds, one or more public structured bonds, and cash as low risk investments 137. In certain embodiments, issuer 120 may guarantee that the value of low risk investments 137 in financial account 130 will not decrease below the amount invested in low risk investments 137. In certain embodiments, financial account 130 may include one or more financial investments 132 associated with multiple financial entities.

In certain embodiments, financial investments 132 within financial account 130 may be selected by issuer 120. In certain embodiments, issuer 120 may restrict the investments 132 available for selection by customer 110 and/or require the value of financial account 130 to be distributed according to a specified asset allocation model. In certain embodiments, issuer 120 may not allow customer 110 to select any investments 132, such that issuer 120 may have complete control over investments 132 in financial account 130. In certain embodiments, the distribution between low risk investments 137 and high risk investments 136 of financial account 130 may automatically rebalance according to financial plan 100. In certain embodiments, the composition of investments 132 in financial account 130 may change in response to one or more elections by customer 110 and/or in accordance with one or more provisions of financial instrument 138. In certain embodiments, the composition of financial account 130 (or one or more sub-accounts) may change based on (a) the amount of time elapsed since customer's 110 initial participation in financial plan 100 (b) the amount of time elapsed since financial instrument 138 was issued and/or (c) the age, gender, and/or health of customer 110.

Financial account 130 may or may not be associated with issuer 120. In certain embodiments, the value of financial account 130 may be withdrawn in whole or in part at the discretion of customer 110.

Financial instrument 138 may represent a financial product for distributing a certain sum of money. In certain embodiments, financial instrument 138 may represent a secure retirement product for providing a guaranteed growth rate and a guaranteed income for life of customer 110. In certain embodiments, financial instrument 138 may include a financial vehicle used to distribute a certain sum of money at specified intervals, such as an annuity. Financial instrument 138 may be issued to customer 110 upon a certain date (i.e., when customer 110 turns fifty years old) or a triggering event. In certain embodiments, a triggering event may be a date selected by customer 110, plan sponsor 118, and/or issuer 120. In certain embodiments, a triggering event may include a certain age of customer 110, a certain number of years customer 110 has been employed by plan sponsor 118, etc.

In certain embodiments, the sum of money used for financial instrument 138 may be based on a principal value, such as the value in financial account 130. In certain embodiments, financial instrument 138 may be immediate or deferred, fixed or variable, and single or multiple payment. In certain embodiments, financial instrument 138 may include one or more deferred variable annuity contracts issued by issuer 120. In certain embodiments, a deferred variable annuity may allow for growth in the value of investments 132 in financial account 130 and, at a future time, provide a stream of payments based upon the value of financial account 130. In certain embodiments, financial instrument 138 may provide additional benefits such as a lifetime payment guarantee 104, growth rate guarantee 106, death benefits 107, living benefits, cash surrender benefits, and/or joint and survivor income payment options.

In embodiments of financial instrument 138 in which financial instrument 138 includes annuity contract 102, annuitization may occur due to an election to annuitize by customer 110 or the terms of annuity contract 102 and/or financial plan 100 may require annuitization on or before a certain date (e.g., when customer 110 turns sixty-five years old). In certain embodiments, annuitization may represent the process of customer 110 exchanging the value of financial account 130 for a stream of payments. In certain embodiments, customer 110 may be provided with multiple annuitization options. For example, customer 110 may be provided with periodic payments for life in an amount equivalent to annual income amount 144. In certain embodiments, the benefits associated with lifetime payment guarantee 104 and growth rate guarantee 106 may be terminated if customer 110 has opted out of these aspects of financial plan 100. Financial instrument 138 is discussed in more detail below in reference to FIG. 4.

Although guarantees are described herein as being provided by issuer 120, in some embodiments, a third party administering financial account 130 may contract with issuer 120 and/or plan sponsor 118 to provide one or more guarantees associated with financial plan 100 and/or financial instrument 138. For example, an insurance company might provide guarantees for investments 132 or other types of financial accounts 130 administered by issuer 120.

Guaranteed base value 139 may represent a base value in association with financial instrument 138, such that beneficiary 114 is guaranteed to receive income for life based on the guaranteed base value 139. In some embodiments, guaranteed base value may be guaranteed to grow in value, such that beneficiary 114 is guaranteed to receive income for like on a value higher than the guaranteed base value 139. In some embodiments, although financial account 130 may decrease due to market fluctuations, guaranteed base value 139 does not, thus providing a guaranteed value regardless of market performance of investments 132 in financial account 130. In certain embodiments, guaranteed base value 139 may represent a base value substantially equal to the balance of financial account 130 at a particular date or upon a triggering event. In certain embodiments, guaranteed base value 139 may be a fixed percentage more or less than financial account 130 or may be a fixed amount more or less than financial account 130. In certain embodiments, a triggering event to determine guaranteed base value 139 may be a date selected by customer 110, plan sponsor 118, and/or issuer 120. In certain embodiments, a triggering event to determine guaranteed base value 139 may include a particular age of customer 110, a certain number of years customer 110 has been employed by plan sponsor 118, etc. In certain embodiments, guaranteed base value 139 may be determined at the same time financial instrument 138 is issued by issuer 120. In certain embodiments, customer 110 and/or plan sponsor 118 may continue to make contributions to financial account 130 after guaranteed base value 139 has been calculated. In certain embodiments, customer 110 may make discretionary withdrawals after guaranteed base value 139 has been calculated. Thus, in certain embodiments, guaranteed base value 139 may increase or decrease based on contributions or discretionary withdrawals made to/from financial account 130.

Protected value 140 may represent a final value in association with financial instrument 138 that beneficiary 114 may be able to receive upon electing to receive withdrawals. In certain embodiments, protected value 140 may represent a value used to calculate one or more benefits, such as a guaranteed withdrawal or income amount. In some embodiments, although financial account 130 may decrease due to market fluctuations, protected value 140 does not, thus providing a guaranteed value regardless of market performance of investments 132 in financial account 130. In certain embodiments, financial plan 100 and/or financial instrument 138 may specify one or more methods to determine protected value 140 at a particular date or upon a triggering event. In particular embodiments, protected value 140 may be the highest of multiple calculated values described below. A first value to determine protected value 140 may be substantially equal to the value of guaranteed base value 140 that has grown at a particular rate (e.g., annual rate of five percent) until the date that final protected value 140 is determined. A second value to determine protected value 140 may be substantially equal to the highest value of financial account 130 at a particular anniversary date (e.g., each birthday of customer 110) for any year preceding the date that protected value 140 is determined. A third value to determine protected value 140 may be substantially equal to the value of financial account 130 on the date that protected value 140 is determined and/or the date that customer 110 elects to take withdrawals from or annuitize financial instrument 138. In alternative embodiments, other suitable methods may be utilized to determine protected value 140. In certain embodiments, triggering events to determine protected value 140 may be selected by customer 110, plan sponsor 118, and/or issuer 120. In certain embodiments, triggering events to determine protected value 140 may include election by customer 110 to lock in their annual income amount 144, a particular age of customer 110, etc. In certain embodiments, protected value 140 may not be established if customer 110 opts out of financial plan 100.

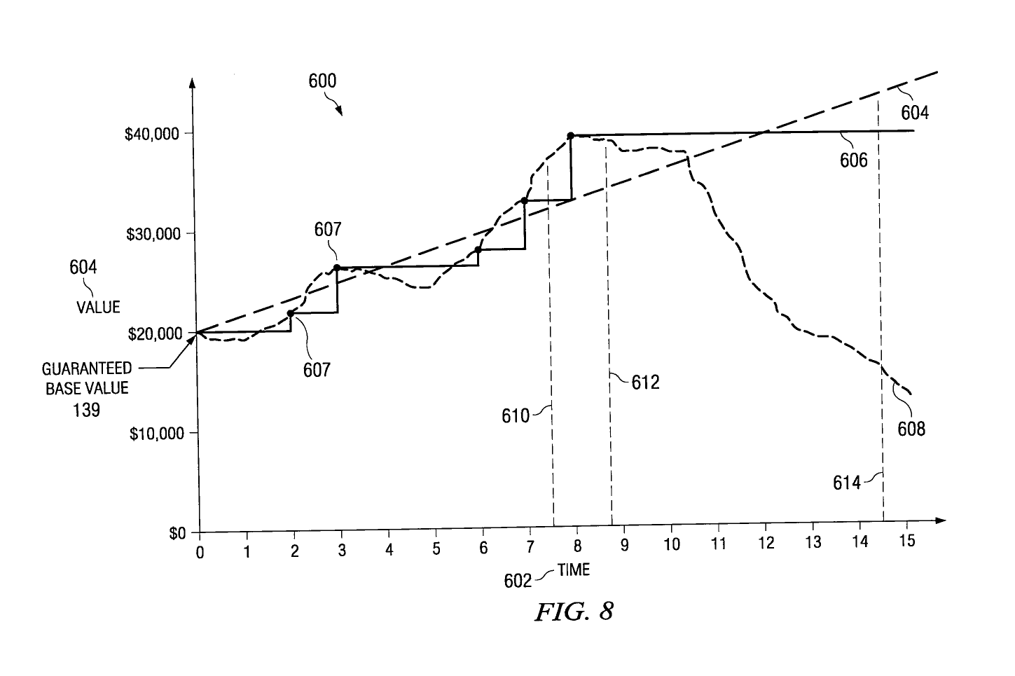

In particular embodiments, protected value 140 may be calculated annually. In some embodiments, protected value 140 may be calculated on a daily basis, at the end of each business day. In some embodiments, protected value 140 may only be calculated upon the date that customer 110 elects to begin withdrawing. In some embodiments, protected value 140 may be based upon a combination of factors and calculated at different times. Depending upon the embodiment, protected value 140 may become fixed at some point in time. For example, protected value 140 may become fixed at the time of the first discretionary withdrawal from financial account 130 by customer 110. In certain embodiments, protected value 140 may decrease upon discretionary withdrawals. Further explanation of an example method for determining protected value 140, is included below in relation to FIG. 8.

Annual income amount 144 represents a guaranteed income transfer for life to customer 110 even if the balance of financial account 130 reaches zero due to poor financial performance of investments 132. Annual income amount 144 may be substantially equal in value to a guaranteed percentage of protected value 140. In certain scenarios, the guaranteed percentage may be determined by the terms and conditions of financial plan 100 and/or financial instrument 138. In certain embodiments, the guaranteed percentage may vary depending on when customer 110 elects to receive annual income amount 144. For example, guaranteed percentage may be four percent if customer 110 elects to receive annual income amount 144 five years after issuance of financial instrument 138 and guaranteed percentage may be five percent if customer 110 elects to receive annual income amount 144 fifteen years after issuance of financial instrument 138. In certain embodiments, annual income amount 144 may be taken as separate partial withdrawals or as systematic withdrawals. For example, annual income amount 144 may be automated and may be set up on a periodic basis by customer 110, issuer 120, or an agent thereof, with the period being yearly, quarterly, monthly, etc.

In certain embodiments, the guaranteed percentage, annual income amount 144, and/or protected value 140 may vary based on certain characteristics of customer 110. For example, the guaranteed percentage or annual income amount 144 may vary based upon the gender, age, and/or health status of one or more of account holder 112, beneficiary 114, and designated party 116. In certain embodiments, the guaranteed percentage, annual income amount 144, and/or protected value 140 may vary depending upon whether and to what extent customer 110 accepts certain limitations on flexibility and/or control over financial account 130 and/or associated distributions.

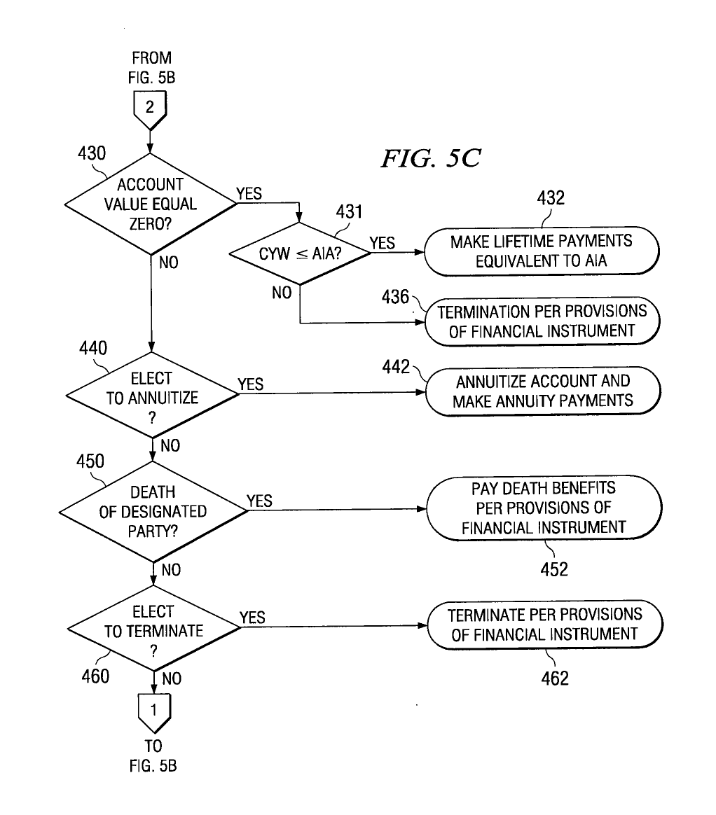

Annual income amount 144 and/or protected value 140 may decrease if customer 110 makes discretionary withdrawals. For example, customer 110 may be allowed to withdraw more than annual income amount 144, but future payments of annual income amount 144 may decrease. Further explanation of the operation of a certain embodiment with respect to protected value 140 and annual income amount 144 is included below in relation to FIGS. 5B and 5C.

In the operation of certain embodiments, customer 110 may automatically receive notice 122 of financial plan 100. Customer 110 may automatically participate in financial plan 100 unless customer 110 opts out of financial plan 100. Upon opting out, customer 110 may be required to acknowledge opting out of one or more aspects of financial plan 110. To opt-out of financial plan, customer 110 may also be required to acknowledge opt-out 123 relinquishing legal rights to file a lawsuit associated with the financial performance of financial account 130 against plan sponsor 118 and/or issuer 120. In certain embodiments, notice 122 of financial plan 100 and/or the storage of opt-outs 123 and acknowledgements 124 may occur electronically.

Issuer 120 and/or plan sponsor 118 may create financial account 130 for customer 110 if customer 110 does not opt-out. Customer 110 and/or plan sponsor 118 may automatically make periodic contributions to financial account 130. In certain embodiments, issuer 110 may make investment choices regarding the allocation of funds associated with financial account 130, such that investment choices are taken away from customer 110. In certain embodiments, the value in financial account 130 may be automatically distributed between low risk investments 137 and high risk investments 136 based on the age of customer 110, such that the percentage of the value in high risk investments 136 generally decreases as customer 110 becomes older.

Upon a particular date or triggering event, such as customer 110 reaching the age of fifty, financial instrument 138 may be issued. Prior to issuance of financial instrument, customer 110 may receive notice 122 that notifies customer 110 of a guaranteed growth rate of financial account 130 and a guaranteed income for life, if customer chooses not to opt-out. Upon issuance of financial instrument 138, guaranteed base value may be determined.

Upon another particular date or triggering event, such as customer reaching the age of sixty-five, protected value 140 may be calculated using one or more specified calculation methods. Customer 110 may make additional contributions to and/or discretionary withdrawals from financial account 130, and protected value 140 and/or annual income amount 144 may be adjusted accordingly. Annual income amount 144 may be determined by applying a guaranteed percentage as specified by financial plan 100 to protected value 140.

In the operation of a particular embodiment, issuer 120 may provide and manage financial plan 100 on behalf of plan sponsor 118 to employees of plan sponsor 118. Plan sponsor 118 may receive indemnification 126, such as litigation insurance, from issuer 120 for the expenses and damages incurred by plan sponsor 118 as to claims associated with the financial performance of financial plan 100 brought by customers 110. Customer 110 may be a new employee at plan sponsor 118. As part of new employee orientation, notice 122 may be sent in an e-mail to customer 110 on behalf of plan sponsor 118, such that the e-mail may include a link to an on-line seminar describing the terms, conditions, and benefits of financial plan 100. Customer 110 may receive an e-mail on behalf of plan sponsor 118 notifying customer 110 of automatic enrollment in financial plan 100 unless customer 110 chooses to opt-out of financial plan 100. If customer 110 chooses to opt-out of financial plan 100, customer 110 may click on a hyperlink in the e-mail that may direct customer 110 to a webpage that includes opt-out 123. Such webpage may also include an electronic button in a graphical user interface that customer 110 can click on to acknowledge opt-out and opt-out of financial plan 100. Upon clicking such button, acknowledgement 124 of opt-out 123 by customer 110 may be stored by issuer 120.

If customer 110 elects not to opt-out, then customer 110 is automatically enrolled in financial plan 100. A particular percentage of the salary of customer 110 is deposited in financial account 130. At a younger age, financial plan 100 may distribute one-hundred percent of such deposit to high risk investments 136 in financial account 130. According to the glidepath of financial plan 100, as customer 110 increases in age, financial plan 100 will begin to increase the distribution percentage of low risk investments 137 in financial account 130.

Upon reaching the age of fifty years old, customer 110 may receive a second notice 122 via e-mail that notifies customer 110 of the end of the glidepath phase and the impending issuance of financial instrument 138. Similar as before, customer 110 is automatically issued financial instrument 138 unless customer 110 opts-out of financial plan 100 by acknowledging opt-out 123. Upon issuance of financial instrument 138, guaranteed base value 139 may be set to the value of financial account 130. Thus, financial plan 100 provides customer 110 guaranteed income for life based on the guaranteed base value 139 even if the value of financial account 130 depreciates severely.

Upon reaching the age of sixty-five years old, customer 110 may elect to begin receiving guaranteed income for life. Annual income amount 144 received by customer 110 may be five percent of protected value 140. As mentioned above, protected value 140 may be the highest of one or more calculated values. Thus, customer 110 is guaranteed to receive annual income amount 144 during the lifetime of customer 110 even if financial account 130 has become depleted.

Although financial plan 100 and/or financial instrument 138 have been described as being purchased or issued directly from issuer 120 in certain embodiments, financial plan 100 and/or financial instrument 138 may be purchased or issued through one or more intermediaries.

FIG. 2 illustrates an example asset distribution within financial account 130. In certain embodiments, all or a portion of financial account 130 may be distributed among high risk investments 136 and low risk investments 137. The combined risk and expected rate of return of the category of low risk investments 137 in financial account 130 are lower than the combined risk and expected rate of return of the category of high risk investments 136. In certain embodiments, issuer 120 may determine which financial investments 132 are considered high risk investments 136 and low risk investments 137. In certain embodiments, financial plan 100 may gradually lower the financial account's 130 exposure to risk by increasing the percentage of value in low risk investments 137 as customer 110 increases in age. Further explanation of an example table for distributing the value of financial account 130 between high risk investments 136 and low risk investments 137, is included below in relation to FIG. 3.

High risk investments 136 may include one or more equities, and, in certain embodiments, high risk investments 136 may include any type of investment 132 that provides a high rate of return, such as a corporate security, a private security, an index fund, a mutual fund, a real estate investment trust, hedge fund, etc. In certain embodiments, the composition of high risk investments 136 and the distribution of value of high risk investments 136 in financial account 130 may change from time to time.

Although low risk investments 137 may include one or more variable rate investments, in certain embodiments, low risk investments 137 may be limited to one or more fixed income investments, such as municipal bonds, bond funds, and money market accounts. In certain embodiments, the composition of low risk investments 137 and the distribution of value in low risk investments 137 in financial account 130 may change from time to time. In a particular embodiment, low risk investments 137 may include one or more private securities, one or more public corporate bonds, one or more mortgage loans, one or more private securities, one or more government bonds, one or more public structured bonds, and cash. In certain embodiments, issuer 120 may guarantee that the value of low risk investments 137 in financial account 130 will not decrease below the amount invested in low risk investments 137.

FIG. 3 illustrates table 200 of an example asset distributions within a financial account 130. Table 200 provides age-based ranges in column 210 for determining distribution values of high risk investments listed in column 212 and distribution values of low risk investments listed in column 214.

Although example age-based thresholds 210 have been illustrated with example table 200 as being based on the age of customer 202, in alternative embodiments, age-based ranges 210 may be based on the age of different parties, the length of time customer has participated in financial plan, and/or upon additional criteria provided in financial plan. Different age thresholds associated with column 210 may be utilized than the examples provided. For example, an age threshold 202 may continue until age ninety. Although table provides example distribution portions 212, 214, any appropriate portions may be used according to the provisions of the terms and conditions of financial plan 100.

FIG. 4 illustrates financial instrument 138 according to a particular embodiment. In the embodiment shown, financial instrument 138 may include annuity contract 102, lifetime payment guarantee 104, growth rate guarantee 106, and death benefit 107. Financial instrument 138 may be issued upon a particular date or a triggering event. In certain embodiments, triggering event may be a date selected by customer 110, plan sponsor 118, and/or issuer 120. In certain embodiments, other triggering events may include a particular age of customer 110, a certain number of years customer 110 has been employed by plan sponsor 118, etc. For example, when customer 110 reaches age fifty, financial instrument 138 may be issued as long as customer 110 does not opt-out of financial plan 100. In certain embodiments, financial instrument 138 may be funded with value of financial account 130. Annuity contract 102 may represent a contract for a broad range of annuity products. For example, annuity contract 102 may represent one or more group deferred variable annuities, such as ANNUITY ONE issued by PRUCO LIFE INSURANCE COMPANY. In certain embodiments, annuity contract 102 may represent a contract between customer 110 and issuer 120, wherein customer 110 may make contributions and/or withdrawals during an accrual phase and then issuer 120 may pay annual income amount to customer 110 during a distribution phase. The transition from the accrual phase to the distribution phase may occur following an election by customer 110, such as annuitizing financial instrument 138. In certain embodiments, transition from the accrual phase to the distribution phase may occur according to the terms and conditions of financial plan 100. In certain embodiments, accrual phase may overlap with the distribution phase.

In addition to the basic terms of annuity contract 102, financial instrument 138 may include additional provisions including lifetime payment guarantee 104, growth rate guarantee 106, and death benefit 107. These additional provisions may be integrated provisions of financial instrument 138 and/or financial plan 100 or they may be included as electable options. Although annuity contract 102, lifetime payment guarantee 104, growth rate guarantee 106, and death benefit 107 are shown as separate elements, one or more of these elements may be combined, and each of these elements may also include numerous components. In certain embodiments, different elements of financial instrument 138 may be purchased, issued, and/or elected at different times. For example, annuity contract 102 may be issued in year one, and lifetime payment guarantee 104, growth rate guarantee 106, and death benefit 107 may be purchased or elected in year one or at anytime thereafter. In some embodiments, financial account 130 remains liquid and all or a portion of financial account 130 may be withdrawn (in some cases with penalty) by customer 110 prior to annuitization of annuity contract 102. Annuitization may or may not even occur depending upon the desires of customer 110.

In certain embodiments, lifetime payment guarantee 104 may include provisions guaranteeing that beneficiary 114 may receive financial transfers for life, beginning at or after a specified triggering event. For example, in certain embodiments, these financial transfers may be due to discretionary withdrawals and/or payments. In certain embodiments, the amount of (and/or a limit for) these financial transfers may be fixed or variable. For example, the amount of (and/or a limit for) these financial transfers may be determined based upon the age, gender, health status, and/or other morbidity factors for one or more individuals. As another example, the amount of (and/or a limit for) these financial transfers may be independent of such factors. In certain embodiments, the amount of (and/or the limit for) these financial transfers may change after a period of time according to a set schedule, changes in an external index, and/or any appropriate factor.

In certain embodiments, the amount of (and/or a limit for) these financial transfers may be annual income amount 144 based upon specified percentages of protected value 140. For example, the amount of (and/or a limit for) annual income amount 144 may be set at a first percentage for a certain period (i.e., four percent five years after customer 110 is issued financial instrument 138) and then change to a second percentage for another period (i.e., five percent fifteen years after customer 110 is issued financial instrument 138). In certain embodiments, these percentages may be fixed upon the date of issuance of financial instrument 138, upon the date of electing lifetime payment guarantee 104, upon the date of electing to receive first annual income amount 144, upon customer's 110 age, or upon any other appropriate date.

In certain embodiments, lifetime payment guarantee 104 may guarantee that beneficiary 114 will receive no less than annual income amount 144 each year for the life of designated party 116. In certain embodiments, if customer 110 is issued financial instrument 138 at age fifty, then annual income amount 144 may be four percent of protected value 140 at age fifty-five and five percent of protected value 140 at age sixty-five, although any percentage may be used. In another example, protected value 140 may be increased by additional deposits and may be decreased by withdrawals greater than annual income amount 144.

In certain embodiments, in addition to or in lieu of lifetime payment guarantee 104, financial instrument 138 may include provisions guaranteeing that beneficiary 114 will receive certain financial transfers over a specified time period, such as a period of years, or a single financial transfer as a lump-sum payment or withdrawal.

In certain embodiments, growth rate guarantee 106 may include provisions guaranteeing a periodic growth rate of guaranteed base value 139. The provisions may further provide that growth rate guarantee 106 may be a specified fixed or variable rate for a specified period of time. For example, growth rate guarantee 106 may be guaranteed to be a fixed five percent rate applied to guaranteed base value 139, including any additional contributions, per year for fifteen years from the date of issuance of financial instrument 138 or until the date of the first annual income amount 144, whichever is sooner.

In certain embodiments, the specified rate for growth rate guarantee 106 may be any positive fixed value. In certain embodiments, the specified rate may be based on one or more variable indices. For example, the specified rate may be based on the Consumer Price Index, a stock market index, and/or the Federal Reserve's discount rate.

In certain embodiments, the specified rate may vary depending on the timing of contributions, the size of contributions, and/or the value of financial account 130. For example, different rates may apply to different contributions or the overall rate may be calculated based on the rates in effect at the time that contributions are made, weighted based on the relative size (or actual size) of the contributions. In certain embodiments, the specified rate may vary based on characteristics of account holder 112, beneficiary 114, and/or designated party 116. For example, the specified rate may vary depending on the gender, age, or health status of designated party 116.

In certain embodiments, the guaranteed growth rate 106 may be set at a first rate for a specified period of time, or until a specified event occurs, and then change to a second rate. For example, the guaranteed growth rate may be zero for the first two years and then may change to a fixed five percent growth rate for the next eight years. In certain embodiments, the growth rate may change numerous times, with the changes occurring based upon specified periods of time and/or upon the occurrence of specified events.

In certain embodiments, the guaranteed growth rate 106 may vary based on changes in market conditions. For example, the guaranteed growth rate may be tied to a change in a specified market index.

In embodiments of financial instrument 138 including death benefit 107, death benefit 107 may include provisions allowing for payments to be made to a recipient designated by account holder 112 and/or beneficiary 114, upon the death of designated party 116. For example, payments made under death benefit 107 may be made to beneficiary 114 upon the death of designated party 116, where designated party 116 is account holder 112. As another example, payments made under death benefit 107 may be made to an identified third party beneficiary upon the death of designated party 116 or beneficiary 114. Death benefit 107 may provide for payment of an amount based upon the value of financial account 130, protected value 140, or some other value identified in death benefit 107. For example, death benefit 107 may provide for payment in the amount of the value of financial account 130 at the time of death. As another example, death benefit 107 may provide for payment in the amount of the value of protected value 140 at the time of death. As yet another example, death benefit 107 may provide for payment in the amount of the highest value of financial account 130 on any anniversary of the effective date of financial instrument 138. In certain embodiments, death benefit 107 may provide for payment in the amount of the highest of multiple calculation methods, such as annual income amount. Although death benefit 107 has been illustrated and described as a separate element of financial instrument 138, death benefit 107 may be formed from multiple components and/or may be included as part of another element of financial instrument 138.

In certain embodiments, financial instrument 138 may provide for an option allowing customer 110 to elect to receive the present value of future guaranteed payments. For example, in embodiments where the charge for lifetime payment guarantee is an up-front charge, financial instrument 138 may allow for customer 110 to cancel lifetime payment guarantee and receive a payment calculated based upon the present value of the guarantee. In these embodiments, the calculation may or may not include an underwriting assessment of the life expectancy of beneficiary 114.

In certain embodiments, financial instrument 138 may be issued (or sold) as an investment contract (such as annuity contract 102) with a variety of options available for election by customer 110. In certain embodiments, these options may include lifetime payment guarantee 104, growth rate guarantee 106, and/or death benefit 107, among others. The present disclosure is intended to cover such embodiments, whether or not such available options are elected by customer 110.

The costs associated with each element of financial instrument 138 and/or financial plan 100 may be assessed together or as separate charges, and the charges may be assessed in different ways. For example, the costs may be assessed as up-front charges, as asset charges, or as charges against withdrawals or payments. In certain embodiments, the costs may be charged periodically and/or may vary over time. For example, there may be no charge for a period of time and/or the charge may increase or decrease over time depending on a variety of factors. In certain embodiments, the costs may be charged in a manner such that the charge is assessed pro-rata over multiple investments or financial accounts 130, according to an election by customer 110, and/or such that the tax consequences of the charge are substantially minimized. In a particular embodiment, the charge for each element is assessed as a daily asset charge against the value of financial account 130 or high risk investments 136. For example, the charge assessed for lifetime payment guarantee 104 and growth rate guarantee 106 may be a sixty basis point charge (0.60 percent per year) assessed against the daily balance of high risk investments 136 within financial account 130. Similarly, the charge assessed for death benefit 107 may be a 140 basis point charge (1.40 percent per year) assessed against the daily balance of high risk investments 136 within financial account 130. In certain embodiments, financial plan 100 may have lower costs than investment plans as a result of automating many of the steps required by financial plan 100 and limiting the flexibility of customer 110.

As indicated above, in certain embodiments, financial instrument 138 may provide for multiple beneficiaries 114 and financial instrument 138 may provide for various persons to exercise control. For example, financial instrument 138 may provide that both a husband and a wife are beneficiaries 114 and designated parties 116. Financial instrument 138 may further provide that the husband may make discretionary withdrawals from financial account 130 and, if the husband pre-deceases the wife, that the wife may make discretionary withdrawals from financial account 130 after the husband's death or the wife may continue as account holder 112 of financial instrument 138. Additionally, financial instrument 138 may further provide that if account value 130 reaches zero during the husband's life, then the husband may receive periodic payments for life and then, upon his death, the wife may receive periodic payments for her life. In certain embodiments, financial instrument 138 may include similar provisions for business partners or other arrangements involving multiple beneficiaries 114 and/or designated parties 116.

FIGS. 5A-5C provide a flowchart 300 illustrating the operation of financial plan 100 according to a particular embodiment. Flowchart 300 is intended to demonstrate an embodiment of financial plan 100 in which certain features of financial plan 100 specified in the terms and conditions of financial plan 100. In certain embodiments, the terms and conditions of financial plan 100 may automatically trigger events, such as elected actions and payment fees.

According to flowchart 300, at step 302, issuer 120 and/or plan sponsor 118 may generate notice 122 of financial plan 100 to customer 110. At step 304, customer 110 may choose to opt-out of financial plan 100 after reading notice. If customer 110 chooses to opt-out, then customer 110 may be required to acknowledge opt-out 123 as describer in step 318 below. If customer 110 chooses not to opt-out, then customer 110 may automatically begin participating in financial plan 100 and continues on to step 306.

At step 306, customer may automatically make contributions, such as a portion of salary, deposited to financial account 130 associated with financial plan 100. In certain embodiments, this automatic deposit may occur every time customer 110 is paid. In certain embodiments, plan sponsor 118 may make additional contributions to financial account 130. The amount of the automatic contributions may be limited by one or more laws or IRS guidelines. At step 308, the value of financial account 130 may be automatically distributed between high risk investments 136 and low risk investments 137, such that the distribution values may depend on the age of customer 110. Typically, the distribution value of high risk investments 136 will lower as customer 110 becomes older, such that customer's 110 exposure to risk is lowered as customer 110 approaches retirement.

At step 310, issuer 120 and/or plan sponsor 118 may determine if a specified date or a triggering event has been reached. Specified date or triggering event may be the date for issuing a financial instrument 138 and/or determining guaranteed base value 139. In certain embodiments, customer 110, plan sponsor 118, and/or issuer 120 may specify this date upon customer's 110 enrollment in participation plan 100. For example, specified date may occur on or before customer's 110 fiftieth birthday. In particular embodiments, specified date may be forty-five days prior to customer's fiftieth birthday. If specified date or triggering event has not been reached, then flowchart may continue to step 306 when another contribution, such as a portion of customer's 110 salary, is automatically deposited to the balance of financial account 130.

If effective date or triggering event has been reached, then at step 312, issuer 120 and/or plan sponsor 118 may generate another notice 122 of financial plan to customer 110, such that notice 122 notifies customer 110 of the impending issuance of financial instrument 138 and the determination of guaranteed base value 139. Thus, notice 122 notifies customer 110 that customer 110 is about to receive a guaranteed income for life unless customer 110 chooses to opt-out of financial plan 100. If customer 110 chooses to opt-out, then customer 110 may be required to acknowledge 124 opting out of one or more aspects of financial plan 100 and/or opt-out 123 as describer in step 318 below. If customer 110 chooses not to opt-out, then customer 110 may be issued financial instrument 138 at step 315.

At step 315, financial instrument 138 may be issued to customer 110. Value of financial instrument 138 may be linked to value of financial account 130. Elections of various options of financial instrument 138 may be automated and/or selected by customer 110, including lifetime payment guarantee 104 and growth rate guarantee 106. At step 316, guaranteed base value 139 may be determined. Guaranteed base value 139 may represent the value of financial account 130 on this date, such that customer 110 is guaranteed to receive at least guaranteed base value 139 despite the financial performance of financial account 130 moving forward. At step 317, customer 110 may designate beneficiaries and/or designated parties. At this point, flowchart 300 moves to step 403 below.

At step 318, if customer 110 has elected to opt-out of financial plan 100, then customer 110 is further required to acknowledge opt-out 123 of one or more aspects of financial plan before customer 110 is allowed to opt-out of financial plan 100. Opt-out 123 and/or acknowledgement 124 may include an affirmation that customer is opting out of a secure retirement fund that guarantees income for life and waiving the right to bring claims against issuer 120 and/or plan sponsor 118 for financial performance of investments 132 made by customer 110 outside of financial plan 100. Customer 110 may be required to perform an action to indicate acknowledgement 124 of opt-out 123 of one or more aspects of financial plan 100, such as clicking a button or signing customer's name. At this point, flowchart 300 continues to step 320 where the paper or electronic copy of acknowledgement 124 and/or opt-out 123 by customer 110 is stored by issuer 120 and/or plan sponsor 118. In certain embodiments, acknowledgment 124 and/or opt-out 123 may be stored as an indicator in a relationship database stored in memory.

At step 404, if additional contributions are made by customer 110 and/or plan sponsor 118, then the value of financial account 130 is increased by the amount of the additional contribution, at step 412. In some cases, contributions may occur automatically as specified in terms and conditions of financial plan 100. If an elected withdrawal is taken at step 406, then the value of financial account 130 is decreased by the amount of the withdrawal and the cumulative yearly withdrawal is calculated at step 408. In certain embodiments, an elected withdrawal may be automated based upon the terms and conditions of financial plan 100. In certain embodiments, the cumulative yearly withdrawal may be the total of all withdrawals made during the particular calendar, fiscal, or contract year. If the withdrawal is the first withdrawal taken in relation to financial instrument 138, at step 410, then protected value 140 and annual income amount 144 are calculated at step 420. Similarly, if additional contributions are made by customer 110 at step 404 and the first withdrawal has already been taken at step 414, then protected value 140 and annual income amount 144 are calculated at step 420. In some embodiments, the additional contributions may not change some or all of these values. Calculating protected value 140 may use the highest value from one of a numerous calculations. If the withdrawal is not the first withdrawal taken in relation to financial instrument 138, at step 410, then protected value 140 is decreased by the amount of the withdrawal at step 416. If the cumulative yearly withdrawal exceeds annual income amount 144, at step 418, then protected value 140 and annual income amount 144 are recalculated at step 422. These and other calculations are discussed in more detail below.

If the value of financial account 130 is equal to zero, at step 430, then there may be multiple possible alternative outcomes. If the value of financial account 130 is equal to zero at step 430 and cumulative yearly withdrawals are less than or equal to annual income amount 144 at step 431, then lifetime benefit payments may be made to customer 110 in an amount equivalent to annual income amount 144, at step 432. If the value of financial account 130 is equal to zero at step 430 and cumulative yearly withdrawals are less than or equal to annual income amount 144 at step 433, then financial instrument 138 may be terminated in accordance with the provisions of financial instrument 138, at step 436.

If financial instrument 138 includes annuity contract 102 and customer 110 elects to annuitize, at step 440, then financial account 130 is annuitized and annuity payments are made pursuant to the provisions of annuity contract 102, at step 442. In certain embodiments, terms and conditions of financial plan 100 may automatically annuitize financial instrument 138. Financial account 130 may cease to exist at this point and its balance may no longer be able to be withdrawn by customer 110. If financial instrument 138 includes death benefit 107 and if customer 110 dies, at step 450, then payments are made pursuant to the provisions of death benefit 107, at step 452. If customer 110 elects to terminate one or more provisions of financial instrument 138, at step 460, then those provisions are terminated in accordance with the terms of financial plan 100 and/or financial instrument 138, at step 462.

The calculations identified in flowchart 300 are dependent upon the particular terms and conditions of financial plan 100 and/or financial instrument 138. Included below are example calculations for particular embodiments of financial plan 100 and/or financial instrument 138. In the example calculations described below, financial instrument 138 is treated as including annuity contract 102, lifetime payment guarantee 104, and growth rate guarantee 106. For the purpose of these calculations, annuity contract 102 is treated as a deferred variable annuity, growth rate guarantee 106 is treated as a guarantee of a five percent growth rate for the first ten years, and lifetime payment guarantee 104 is treated as annual income amount 144. Unless otherwise indicated, it will be assumed that financial instrument 138 was issued with an initial deposit substantially equal to value in financial account 130 and no additional contributions have been made.

Each time that a withdrawal is made, the value of financial account 130 may be reduced by the amount of the withdrawal. In one embodiment, on the date of the first elected withdrawal, protected value 140 may be set at the greatest of the current value of financial account 130, the highest value of financial account on the date of customer's birthday of any year falling between the date of issuance of financial instrument 138 and the date of the first elected withdrawal, or the guaranteed base value 139 growing at five percent per year compounded. Using these assumptions, on the date of the first withdrawal, annual income amount 144 may be set at a fixed percent of protected value 140, as specified by terms and conditions of financial plan 100 and/or financial instrument 138, at the time that protected value 140 is initially determined. For example, annual income amount 144 may be a fixed five percent of protected value 140. In particular embodiments, the percentages and/or methods of determining annual income amount 144 may vary.

For example, suppose financial instrument is issued on Apr. 1, 2005 with a guaranteed base value 139 of $100,000 substantially equal to value of financial account 130 on this date. The first elected withdrawal takes place on Feb. 1, 2006 when the value of financial account 130 is equal to $101,500. The value of financial account 130 on customer's birthday on Jul. 1, 2005 is equal to 102,500. Protected value 140 would initially be calculated as the greater of $101,500, $102,500 or $104,175.

$100,000×(1.05)(306/365)=$104,175

Thus, protected value 140 would be $104,175. It should be noted that this is only an example embodiment, and certain embodiments of financial plan 100 and/or financial instrument 138 may require customer 110 to wait a certain number of years after issuance of financial instrument 138 before electing to make a withdrawal and determining guarantee income amount 144. Accordingly, based on the assumptions above, annual income amount 144 would be $5,209.

$104,175×0.05=$5,209

If the cumulative withdrawals in a given year exceed annual income amount 144, protected value 140 and annual income amount 144 may be recalculated going forward. Suppose that the current value of financial account 130 is $55,000 and annual income amount 144 is $5,000. The first withdrawal during the applicable year is $7,000, which is $2,000 greater than annual income amount 139 provided per year. The first step in the calculation would be to subtract annual income amount 144 from the current value of financial account 130. Thus, the value of financial account 130 would be reduced to $50,000. ($55,000−$5,000=$50,000) The next step is to calculate the new annual income amount 144. Annual income amount 144 would decrease according to the percentage of the excess amount to the value of financial account 130 prior to the excess being deducted. Thus, annual income amount 144 may drop to $4,500 for subsequent years.

(1−($2,000/$50,000))×$5,000=$4,800

The excess withdrawal amount would then be subtracted from the value of financial account 130. Thus, after the withdrawal, the value of financial account 130 would be $48,000. Protected value 140 would similarly be reduced by the amount of the $7,000 withdrawal.

In certain embodiments, withdrawals that reduce the value of financial account 130 below a specified minimum amount will not be allowed if they are greater than the annual income amount 144. In certain embodiments, provisions in financial plan 100 and/or financial instrument 138 may allow for exceptions to accommodate certain provisions of the tax code. For example, if financial plan 100 and/or financial instrument 138 is subject to required minimum distributions under the tax code, then financial instrument 138 may provide that required withdrawals will not reduce annual income amount 144.

Each time that an additional contribution is made, the value of financial account 130 may be increased by the amount of the contribution. If a withdrawal has been made prior to the additional contribution, then protected value 140 may also be increased by the amount of the additional contribution, annual income amount 144 may be increased by five percent of the additional contribution. For example, suppose protected value 140 is $50,000 and annual income amount 144 is $5,000. If customer 110 makes an additional contribution of $42,400, then protected value 140 would increase to $92,400. ($50,000+$42,400=$92,400). Annual income amount 144 may increase to $7,120.

($42,400×0.05)+$5,000=$7,120

Again, the percentages may vary and the ability to make contributions may be controlled.

Although FIGS. 5A, 5B, and 5C disclose one embodiment, various steps may be added or omitted without departing from the scope of the disclosure. In addition, some of the illustrated steps could be performed differently or in a different order without departing from the scope of the disclosure.

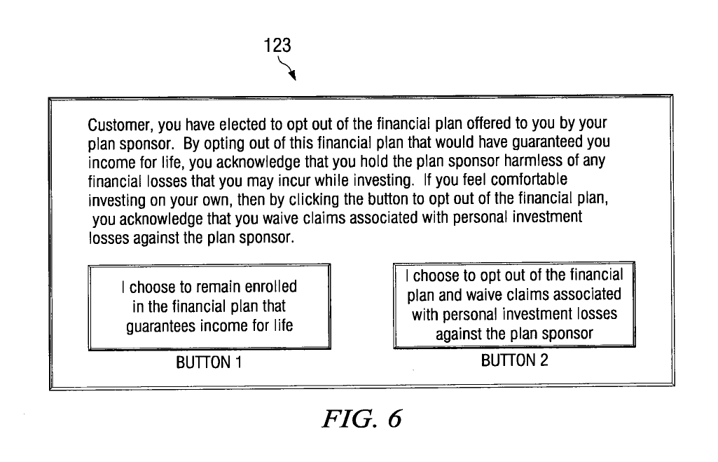

FIG. 6 illustrates an example financial plan opt-out opt-out 123 and acknowledgement 124 of financial plan 100 to customer 110. As illustrated in FIG. 6, opt-out 123 may be electronically generated and displayed to customer. Acknowledgement 124 of opt-out 123 by customer may occur when customer 110 clicks button two that indicates that customer 110 chooses to opt-out of financial plan 110 and waive claims associated with personal investment losses against plan sponsor 118. Upon clicking button two, a copy of acknowledgement 124 of opt-out may be stored by issuer 120 and/or plan sponsor 118.

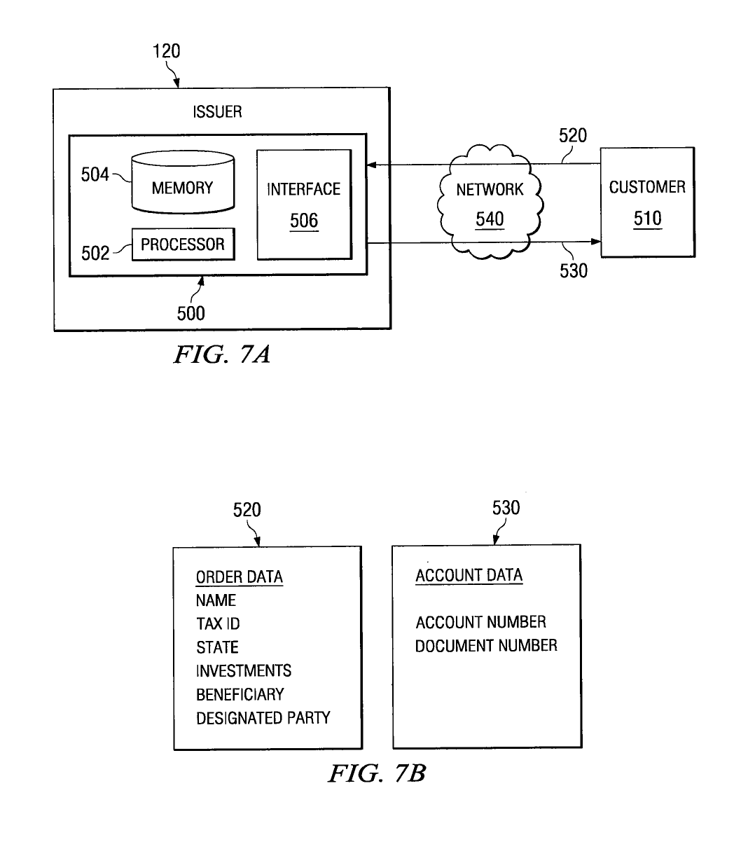

FIGS. 7A and 7B illustrate an example data processing system 500 for providing financial plan 100 according to a particular embodiment. While in certain embodiments financial plan 100 is entered into without using a computer, other embodiments may have a computerized option for entering into financial plan 100. Furthermore, generation of notice 122, opt-out 123, acknowledgement 124, and storage of opt-out 123 and/or acknowledgement 124 may also have a computerized option. Data processing system 500 represents hardware and controlling logic for presenting and managing financial plan 100 and/or financial instrument 138. In the embodiment shown, data processing system 500 may include one or more processors 502, memory 504, and interface 506. As shown, data processing system 500 may be included as a system controlled by issuer 120. However, in other embodiments data processing system 500 may be external to issuer 120. In certain embodiments, data processing system 500 may be controlled by plan sponsor 118. In certain embodiments, certain portions of data processing system 500 may be controlled by plan sponsor 118 and certain other portions may be controlled by issuer 120. Additionally, although data processing system 500 is shown as a single system, data processing system 500 may be distributed across multiple platforms housed in multiple locations, some or all of which may or may not be controlled by issuer 120.

Processor 502 may control the operation and administration of elements within data processing system 500 by processing information received from interface 506 and memory 504. Processing module 502 may include any hardware and/or controlling logic elements operable to control and process information. For example, processing module 502 may be a computer, programmable logic device, a microcontroller, and/or any other suitable device or group of devices. In certain embodiments, processor 502 may automatically contribute a portion of customer's salary to financial account 130. In certain embodiments, processor 502 may allocate all or a portion of contribution across one or more investments 132 in financial account 130. In certain embodiments, processor 502, may periodically distribute the value of financial account 130 between a category of high risk investments 136 and a category of low risk investments 137, such that the percentage of the value including low risk investments 137 generally increases as customer 110 gets older. In certain embodiments, processor 502, may calculate protected value 140, such that processor may determine the highest value from one of a numerous calculations. In certain embodiments, processor 502 may recognize particular dates or triggering events.

Memory 504 may store, either permanently or temporarily, data and other information for processing by processing module 502 and communication using interface 506. Memory 504 may include any one or a combination of volatile or nonvolatile local or remote devices suitable for storing information. For example, memory 504 may include random access memory (RAM), read only memory (ROM), magnetic storage devices, optical storage devices, or any other suitable information storage device or combination of these devices. Memory 504 may store, among other things, order data 520, account data 530, and copies of acknowledgements 124 and/or opt-outs 123. In certain embodiments, memory 504 may include a relational database operable to store indicators. In certain embodiments, indicators may indicate acknowledgement 124 of opt-outs 123 for one or more customers 110. In certain embodiments, memory 504 may store the terms and conditions of financial plan 100 and/or financial instrument 138 for each customer 110.

Interface 506 communicates information to and receives information from devices or systems coupled to data processing system 500. For example, interface 506 may communicate with other elements controlled by issuer 120, network 540, and/or elements coupled to network 540. Thus interface 506 may include any hardware and/or controlling logic used to communicate information to and from elements coupled to data processing system 500.

Network 540 represents communication equipment, including hardware and any appropriate controlling logic, for interconnecting elements coupled to network 540. Thus network 540 may represent a local area network (LAN), a metropolitan area network (MAN), a wide area network (WAN), and/or any other appropriate form of network. Furthermore, elements within network 540 may utilize circuit-switched, packet-based communication protocols and/or other communication protocols to provide for network communications. The elements within network 540 may be connected together via a plurality of fiber-optic cables, coaxial cables, twisted-pair lines, and/or other physical media for transferring communications signals. The elements within network 540 may also be connected together through wireless transmissions, including infrared transmissions, 802.11 protocol transmissions, laser line-of-sight transmissions, or any other wireless transmission method.

In operation, order data 520 may be transmitted from customer 510 to data processing system 500 through network 540. Although customer 510 is illustrated in FIG. 7A, in certain embodiments, order data 520 may be transmitted from plan sponsor 118 through network 540. Data processing system 500 may process order data 520, generate account data 530, and transmit account data 530 to issuer 118 through network 540. In certain embodiments, customer 110 and/or plan sponsor 118 may make contributions to issuer through network 540.

Order data 520 may include the name of account holder 112, one or more tax identifiers, the resident state of account holder 112, an initial investment allocation designation, birth date of account holder 112, and a designation of beneficiary 114 and/or designated party 116. In certain embodiments, among other information, order data 520 may also include information related to the selection of one or more electable options. Account data 530 may include an account number and a document, or reference to a document, containing the provisions of financial plan 100 and/or financial instrument 138.

Upon receipt of order data 520, data processing system 500 may store all or a portion of order date 520 in memory 504. For example, data processing system 500 may store one or more identifiers for account holder 112, such as a name, a tax identifier, etc. As another example, data processing system 500 may store information identifying selected options. Data processing system 500 may calculate any applicable fees associated with the provisions of financial plan 100 and/or financial instrument 138, including any selected options. Data processing system 500 may also identify financial account 130 and identify assets and fees associated with financial account 130.

In certain embodiments, customer 510 may initiate the transmission of order data 520 through the use of a web-based application. For example, customer 510 may access one or more websites and may submit certain portions of order data 520 using those websites. Similarly, customer 510 may use Internet technologies to enroll in financial plan 100 and/or access details of financial plan 100, including financial account 130 information. The use of internet technologies to enroll in financial plan 100 or affirm opt-out 123 and/or acknowledgement 124 may involve the use of one or more security provisions such as digital signatures, digital certificates, passwords, and encryptions. In certain embodiments, the collection of order data 520 may occur through the use of an interactive process. For example, a web-based application may present a series of questions to customer 510, which customer 510 may respond to and, in responding, submit the contents of order data 520.

FIG. 8 illustrates an example chart 600 for determining protected value 140. Example chart 600 includes vertical axis 604 representing monetary values and horizontal axis 602 representing time that has elapsed since the issuance of financial instrument 138. In this example chart, issuance of financial instrument 138 is assumed to occur at time zero. Thus, financial instrument is initially funded with $20,000. Guaranteed base value 139 is also determined to be equal to $20,000. In particular embodiments, protected value 140 may be the highest of three values described below. A first value, guaranteed growth value 604, to determine protected value 140 may be substantially equal to the value of guaranteed base value 140 that has grown at particular rate (i.e., at an annual rate of five percent in this example) until the date that protected value 140 is determined. A second value, highest anniversary value, 606 to determine protected value 140 may be substantially equal to the highest value of financial account at a particular anniversary date 607 occurring once a year (i.e., customer's 110 birthday) for any year following issuance of financial instrument 138 and preceding the date that protected value 140 is determined. A third value, account value 608, to determine protected value 140 may be substantially equal to the value of financial account 130 on the date that protected value 140 is determined.

In a first example 610 occurring between years seven and eight from issuance of financial instrument 138, guaranteed growth value 604 may be $28,000, highest anniversary value 606 may be $31,000, and account value 608 may be $36,000. Thus, protected value 140 may be equal to account value 608 because this is the highest of the calculated values.

In a second example 612 occurring between years eight and nine from issuance of financial instrument 138, guaranteed growth value 604 may be $30,000, highest anniversary value 606 may be $37,000, and account value 608 may be $35,000. Thus, protected value 140 may be equal to highest anniversary value 606 because this is the highest of the calculated values, and customer 110 is able to receive protected value 140 higher than the actual value of customer's 110 financial account 130.

In a third example 614 occurring between years fourteen and fifteen from issuance of financial instrument 138, guaranteed growth value 604 may be $40,000, highest anniversary value 606 may be the $37,000 occurring at year eight, and account value 608 may be $15,000. Thus, protected value 140 may be equal to guaranteed growth value 604 because this is the highest of the calculated values, and customer 110 is able to receive protected value 140 much higher than the actual value of customer's 110 financial account 130.

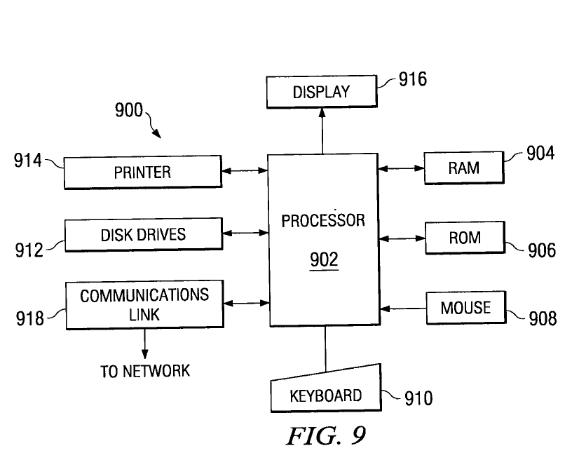

FIG. 9 is an embodiment of a general purpose computer 900 that may be used in connection with one or more pieces of software used to implement the embodiments of disclosure. General purpose computer 900 may generally be adapted to execute any of the well-known OS2, UNIX, Mac-OS, Linux, and Windows Operating Systems or other operating systems. The general purpose computer 900 in this embodiment comprises a processor 902, a random access memory (RAM) 904, a read only memory (ROM) 906, a mouse 908, a keyboard 910 and input/output devices such as a printer 914, disk drives 912, a display 916 and a communications link 918. In other embodiments, the general purpose computer 900 may include more, less, or other component parts. Embodiments of the present disclosure may include programs that may be stored in the RAM 904, the ROM 906 or the disk drives 912 and may be executed by the processor 902. For example, RAM 904, ROM 906, or disk drives 912 may store, among other things, order data 520, account data 530, and copies of acknowledgements 124 and/or opt-outs 123. In certain embodiments, disk drives 912 may include a relational database operable to store indicators. In certain embodiments, indicators may indicate acknowledgement 124 of opt-outs, and/or opt-outs 123 for one or more customers 110. In certain embodiments, RAM 904, ROM 906, or disk drives 912 may store the terms and conditions of financial plan 100 and/or financial instrument 138 for each customer 110.

The communications link 918 may be connected to a computer network or a variety of other communicative platforms including, but not limited to, a public or private data network; a local area network (LAN); a metropolitan area network (MAN); a wide area network (WAN); a wireline or wireless network; a local, regional, or global communication network; an optical network; a satellite network; an enterprise intranet; other suitable communication links; or any combination of the preceding. Disk drives 912 may include a variety of types of storage media such as, for example, floppy disk drives, hard disk drives, CD ROM drives, DVD ROM drives, magnetic tape drives or other suitable storage media.

Although FIG. 9 provides one embodiment of a computer that may be used with certain embodiments of the disclosure, certain embodiments of disclosure may additionally utilize computers other than general purpose computers as well as general purpose computers without conventional operating systems. Additionally, embodiments of the disclosure may also employ multiple general purpose computers 900 or other computers networked together in a computer network. Most commonly, multiple general purpose computers 900 or other computers may be networked through the Internet and/or in a client server network. Embodiments of the disclosure may also be used with a combination of separate computer networks each linked together by a private or a public network.

Several embodiments of the disclosure may include logic contained within a medium. In the embodiment of FIG. 9, the logic comprises computer software executable on the general purpose computer 900. The medium may include the RAM 904, the ROM 906 or the disk drives 912. In other embodiments, the logic may be contained within hardware configuration or a combination of software and hardware configurations. The logic may also be embedded within any other suitable medium without departing from the scope of the disclosure.

For example, in certain embodiments, processor 902 may automatically contribute a portion of customer's 110 salary to financial account 130. In certain embodiments, processor 902 may allocate all or a portion of contribution across one or more investments 132 in financial account 130. In certain embodiments, processor 902 may periodically distribute the value of financial account 130 between a category of high risk investments 136 and a category of low risk investments 137, such that the percentage of the value including low risk investments 137 generally increases as customer 110 gets older. In certain embodiments, processor 902 may calculate protected value 140, such that processor may determine the highest value from one of a numerous calculations. In certain embodiments, processor 902 may recognize particular dates or triggering events.

Although the present disclosure has been described in several embodiments, a myriad of changes and modifications may be suggested to one skilled in the art, and it is intended that the present disclosure encompass such changes and modifications as fall within the present appended claims.

To aid the Patent Office, and any readers of any patent issued on this application in interpreting the claims appended hereto, applicants wish to note that they do not intend any of the appended claims to invoke ¶6 of 35 U.S.C. §112 as this paragraph and section exists on the date of filing hereof unless “means for” or “step for” are used in the particular claim.

What is claimed is:

1. A financial plan management system, comprising:
one or more processors;
one or more memory modules; and
software stored on computer-readable media and, when executed by the one or more processors, operable to:
store, in the one or more memory modules, of an account holder, identifying information for an account holder participating in a financial plan;
allocate all or a portion of a financial contribution to a financial account having a plurality of financial investments, the plurality of financial investments comprising at least one investment from each of a high risk investment category and a low risk investment category, wherein the combination of investments in the high risk investment category have a higher expected rate of return and a higher risk than the combination of investments in the low risk investment category;
periodically distribute a balance of the financial account such that a first portion of the balance of the financial account is invested in one or more investments from the high risk investment category and a second portion of the balance of the financial account is invested in one or more investments from the low risk investment category, wherein a ratio of the first portion to the second portion is generally decreased over a period of time;
in response to a first triggering event:
determine a base value, the base value being substantially equal to the balance of the financial account;
in response to a second triggering event:
calculate a protected value, wherein the protected value is at least equal to the base value; and
calculate an income amount based on the protected value that a beneficiary is guaranteed to receive on a periodic basis.

2. The financial plan management system of claim 1, wherein the first portion is between sixty-five percent to seventy-five percent of the balance of the financial account when the account holder is fifty years old.

3. The financial plan management system of claim 1, wherein the periodic basis is yearly.

4. The financial plan management system of claim 1, wherein the beneficiary comprises the account holder.

5. The financial plan management system of claim 1, wherein the base value is used to determine the income amount that the account holder is guaranteed to receive.

6. The financial plan management system of claim 1, wherein the second portion is determined based on the age of the account holder.

7. The financial plan management system of claim 1, wherein the base value grows at a minimum positive growth rate.

8. The financial plan management system of claim 1, wherein the identifying information comprises the account holder's birth date and social security number.

9. The financial plan management system of claim 1, wherein the protected value is a greatest value determined from one or more calculated values, the one or more calculated values comprising:
a guaranteed growth value determined by applying a fixed rate of growth to the base value;
an anniversary value determined by taking a highest balance of the financial account from each anniversary for a period between the first triggering event and the second triggering event; and
the balance of the financial account.

10. The financial plan management system of claim 1, wherein the financial plan comprises provisions for the account holder to opt-out prior to the first triggering event.

11. The financial plan management system of claim 1, wherein the contribution is a rate between two percent to twenty-five percent of a salary of the account holder.

12. The financial plan management system of claim 1, wherein the one or more financial investments are selected by an issuer.

13. The financial plan management system of claim 1, wherein the high risk investment category comprises one or more equity investments.

14. The financial plan management system of claim 1, wherein the low risk investment category comprises one or more bond funds.

15. The financial plan management system of claim 1, wherein the financial plan is offered within a 401(k) plan.

16. The financial plan management system of claim 1, wherein the income amount is a fixed rate between four percent to six percent of the protected value.

17. The financial plan management system of claim 1, wherein the first triggering event comprises the account holder reaching an age of fifty years old.

18. The financial plan management system of claim 1, wherein the second triggering event comprises the account holder electing to make a withdrawal from the financial account.

19. A financial plan management method, comprising:
storing identifying information for an account holder, the account holder participating in a financial plan;
allocating all or a portion of a financial contribution to a financial account having a plurality of financial investments, the plurality of financial investments comprising at least one investment from each of a high risk investment category and a low risk investment category, wherein the combination of investments in the high risk investment category have a higher expected rate of return and a higher risk than the combination of investments in the low risk investment category;
periodically distributing a balance of the financial account such that a first portion of the balance of the financial account is invested in one or more investments from the high risk investment category and a second particular percentage of the balance of the financial account is invested in one or more investments from the low risk investment category, wherein a ratio of the first portion to the second portion is generally decreased over a period of time;
in response to a first triggering event:
determining a base value, the base value being substantially equal to the balance of the financial account;
in response to a second triggering event:
calculating a protected value, wherein the protected value is at least equal to the base value; and
calculating an income amount based on the protected value that a beneficiary is guaranteed to receive on a periodic basis.

20. The method of claim 19, wherein the first portion is between sixty-five percent to seventy-five percent of the balance of the financial account when the account holder is fifty years old.

21. The method of claim 19, wherein the periodic basis is yearly.

22. The method of claim 19, wherein the beneficiary comprises the account holder.

23. The method of claim 19, wherein the base value is used to determine the income amount that the account holder is guaranteed to receive.

24. The method of claim 19, wherein the second portion is determined based on the age of the account holder.

25. The method of claim 19, wherein the base value grows at a minimum positive growth rate.

26. The method of claim 19, wherein the identifying information comprises the account holder's birth date and social security number.

27. The method of claim 19, wherein the protected value is a greatest value determined from one or more calculated values, the one or more calculated values comprising:
a guaranteed growth value determined by applying a fixed rate of growth to the base value;
an anniversary value determined by taking a highest balance of the financial account from each anniversary for a period between the first triggering event and the second triggering event; and
the balance of the financial account.

28. The method of claim 19, wherein the financial plan comprises provisions for the account holder to opt-out prior to the first triggering event.

29. The method of claim 19, wherein the contribution is a rate between two percent to twenty-five percent of a salary of the account holder.

30. The method of claim 19, wherein the one or more financial investments are selected by an issuer.

31. The method of claim 19, wherein the high risk investment category comprises one or more equity investments.

32. The method of claim 19, wherein the low risk investment category comprises one or more bond funds.

33. The method of claim 19, wherein the financial plan is offered within a 401(k) plan.

34. The method of claim 19, wherein the income amount is a fixed rate between four percent to six percent of the protected value.

35. The method of claim 19, wherein the first triggering event comprises the account holder reaching an age of fifty years old.

36. The method of claim 19, wherein the second triggering event comprises the account holder electing to make a withdrawal from the financial account.

37. A financial plan, comprising:
a financial account having an account balance and a plurality of financial investments, the plurality of financial investments comprising at least one investment from each of a high risk investment category and a low risk investment category, wherein the combination of investments in the high risk investment category have a higher expected rate of return and a higher risk than the combination of investments in the low risk investment category, wherein the account balance is periodically distributed such that a first portion of the balance of the financial account is invested in one or more investments from the high risk investment category and a second portion of the balance of the financial account is invested in one or more investments from the low risk investment category, wherein a ratio of the first portion to the second portion is generally decreased over a period of time;
a base value being substantially equal to the balance of the financial account such that the guaranteed base value being determined in response to a first triggering event;
a protected value, wherein the protected value is at least equal to the base value, the protected value being determined in response to a second triggering event; and
an income amount based on the protected value that a beneficiary is guaranteed to receive on a periodic basis.

38. The financial plan of claim 37, wherein the first portion is between sixty-five percent to seventy-five percent of the balance of the financial account when the account holder is fifty years old.

39. The financial plan of claim 37, wherein the periodic basis is yearly.

40. The financial plan of claim 37, wherein the beneficiary comprises the account holder.

41. The financial plan of claim 37, wherein the base value is used to determine the income amount that the account holder is guaranteed to receive.

42. The financial plan of claim 37, wherein the second portion is determined based on the age of the account holder.

43. The financial plan of claim 37, wherein the minimum positive growth rate is a fixed rate between four percent and six percent.

44. The financial plan of claim 37, wherein the identifying information comprises the account holder's birth date and social security number.

45. The financial plan of claim 37, wherein the protected value is a greatest value determined from one or more calculated values, the one or more calculated values comprising:
a guaranteed growth value determined by applying a fixed rate of growth to the base value;
an anniversary value determined by taking a highest balance of the financial account from each anniversary for a period between the first triggering event and the second triggering event; and
the balance of the financial account.

46. The financial plan of claim 37, wherein the financial plan comprises provisions for the account holder to opt-out prior to the first triggering event.

47. The financial plan of claim 37, wherein the contribution is a rate between two percent to twenty-five percent of a salary of the account holder.

48. The financial plan of claim 37, wherein the one or more financial investments are selected by an issuer.

49. The financial plan of claim 37, wherein the high risk investment category comprises one or more equity investments.

50. The financial plan of claim 37, wherein the low risk investment category comprises one or more bond funds.

51. The financial plan of claim 37, wherein the financial plan is offered within a 401(k) plan.

52. The financial plan of claim 37, wherein the base value grows at a minimum positive growth rate.

53. The financial plan of claim 37, wherein the first triggering event comprises the account holder reaching an age of fifty years old.

54. The financial plan of claim 37, wherein the second triggering event comprises the account holder electing to make a withdrawal from the financial account.
